(19) United States
(12) Patent Application Publication
(10) Pub. No.: US 2004/0009696 A1
(43) Pub. Date: Jan. 15, 2004

(54) Connector bridging device

(76) Inventor: Colin Michael Kelly, Redding, CT (US)

Correspondence Address: Colin M. Kelly, 718 Redding Rd., Redding, CT, 06896, US

(21) Appl. No.: 10/193,593

(22) Filed: Jul. 11, 2002

(51) Int. Cl. H01R 13/627

(52) U.S. Cl. 439/357

(57) ABSTRACT

A connection bridge is provided to enhance the engagement between a headphone connection jack and the portable music player. The connection bridge includes a selectively shaped engagement ring for attachment to the connection jack. A positive engagement to the player is created by one or more prongs that extend from the bridge to corresponding ports in the player. This arrangement prevents the inadvertent disconnection between headphones and players that plague these popular devices.

The present invention is directed to a novel accessory for use with a personal audio and/or video product. More particularly, the present invention is directed to an attachment enhancement for securing the connections between various headset assemblies and a player of audio and/or video content.

### FIELD OF THE INVENTION

For the last two decades, there has been an incredible growth of the use of personal stereo devices for individual enjoyment of music and the like. These devices are designed for portable operation, usually driven by battery or solar power and have musical content stored on optical or magnetic media that is exchangeable within the unit. Illustrative examples include the walkman and diskman products distributed by the Sony Corporation of America. The Walkman is a small, fully integrated cassette stereo player, with headphones connected via detachable cord. The Diskman is similar, but instead of a removable cassette for musical content storage, the music is stored on a removable compact disc or “CD.” More recently, this trend has encompassed portable devices that store music in digital media such as minidisk or semiconductor memory—flashcard—storage, formatted using compression algorithms such as the “MP3” standard.

As these products grew in popularity, so did their use. Indeed, these units are now being designed for more severe environments that subject the electronics within the device to high levels of vibration, temperature and moisture extremes. These environments are encountered on a more routine basis, as the owners of the portable devices increasingly take them out running, skiing, to the beach, etc. Innovations in this area, designed for these uses include the use of memory buffers to hold music sequences temporarily, thus providing a smooth reproduction even when the flow is interrupted by physical bumps and the like.

As an outcome of this activity, the unit design has become more rugged. However, an unexpected fall-out of this is that the headgear and its connection to the music generating electronics have become increasingly more difficult to maintain. Indeed, most manufacturers continue to rely on a friction fit connection to hold the stereo plug of the headphones in its connection port to the portable device. This arrangement is perhaps somewhat cost effective, but insufficient for many uses, resulting in disconnected cords at inopportune moments of operation. Specifically, users of the devices are often confronted with a greater frequency of disconnects at critical times of operation, or when a reconnect is difficult to perform. In addition to the annoyance, efforts to reconnect while performing some athletic endeavors create additional safety hazards to the users and possibly others.

### SUMMARY AND OBJECTS OF THE PRESENT INVENTION

It is therefor an object of the present invention to provide a connection between the headphones and a portable electronic device that resists separation during extreme conditions of use.

It is yet another object of the present invention to provide a attachment assembly to facilitate and strengthen the interconnect of the headphone cord with the music port of the player.

It is still a further object of the present invention to provide an accessory for use with the population of existing portable music players to enhance the connection of the headphones cord to the player in a cost effective manner.

The above and other objects of the present invention are realized in a attachment accessory for use with select portable and/or personal stereo devices. The assessory is configured to couple with the male connector post for a headphone set and includes two parallel extensions that are insertable into complementary female ports with interference protrusions for engagement. Upon insertion, the accessory provides a positive engagement between the headphone post and portable player.

The foregoing inventive features will be better understood upon review of the following detailed description, taken in conjunction with the drawings of the invention as provided below:

### DETAILED DESCRIPTION OF THE DRAWINGS

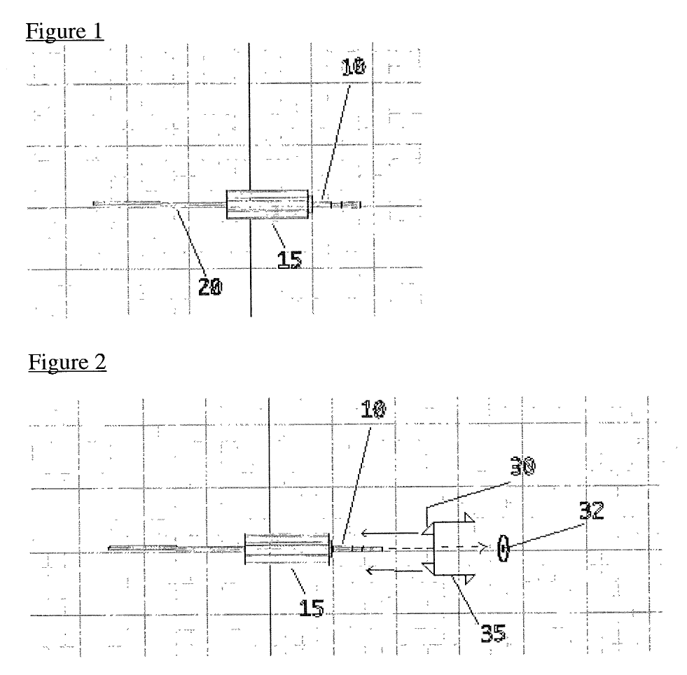

FIG. 1 provides a schematic diagram of the connecting plug for a set of typical headphones to be addressed by the present invention;

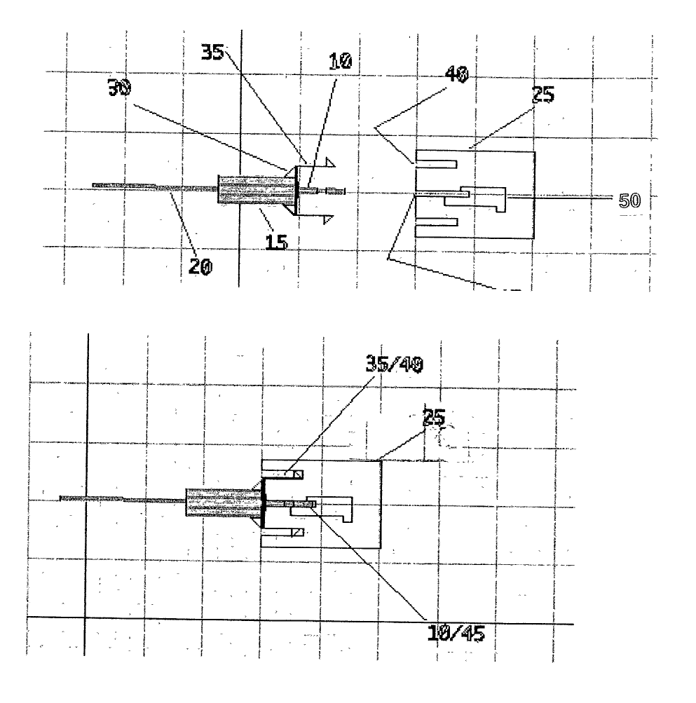

FIG. 2 provides a series of three separate views depicting the use of the inventive connector accessory in conjunction with the connection plug and portable player; and

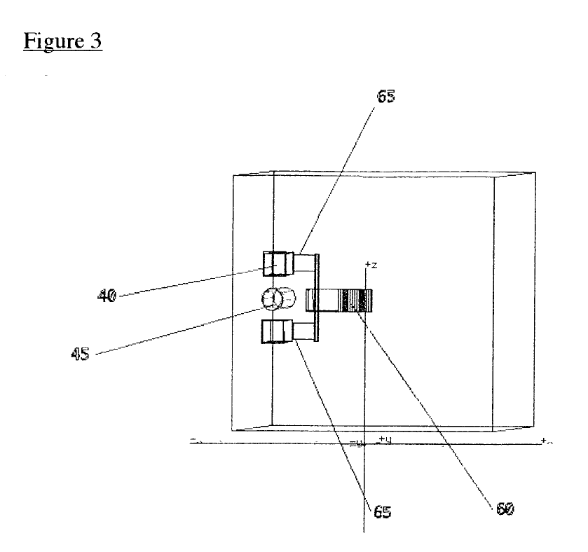

FIG. 3 provides a orthogonal view of the player module for use with the retaining switch associated with one embodiment of the present invention.

### DESCRIPTION OF THE INVENTION

First briefly in overview, the present invention is directed to a line of accessories for use with personal and/or portable music players and the like. The inventive accessory provides an enhanced connection between the player and the players headset or headphones, allowing for ease of connection and disconnection, but providing a positive connection that is difficult to inadvertently disconnect by jarring impact or vibrations that accompany general physical activities.

The above is accomplished by providing a bridging device, which couples to the headphone-connecting plug and allows for a more positive connection to the player. In one variation of this, the player module supporting the headphone connection includes ports that interlock with the bridging device. These interlocks include a positive barrier switch that is user-controlled and allows for interference engagement of bridging prongs to provide a locking of the connector into the module.

Turning now to FIG. 1, a schematic view of the connecting plug for a typical headphone set is provided, wherein the headphones (not shown) are connected first to the connector base 15 by wire 20. Extending from the connector base 15 is the headphone connector 10, made of a conducting material—preferably steel—with two surfaces separated to allow for two signal connections with the player (“stereo”). Connector base 15 is often made of non-conducting materials such as polyethylene or other suitable plastics.

In FIG. 2, the connecting plug is shown in a series of diagrams that demonstrate the attachment and connection of the inventive bridge to (i) the connecting plug and (ii) the player. Specifically, as shown, the bridge includes a center opening 32 (see view A-A) that corresponds to the connector 10 and allows insertion thereof while maintaining the connectors properly centered position. Support flanges 30 extend from the bridge and are dimensioned to snugly fit over the connection base 15 via sliding engagement therewith. Once placed onto the connector base 15, the bridge provides one or more bridging prongs 35 (two are shown in FIG. 2), in parallel alignment with the connector 10.

Continuing in FIG. 2, the bridge is shown positioned for engagement with a player and specifically a connecting module within the player, 25. This module includes ports for receiving the connector 10 and each of the associated bridging prongs 35. As depicted, ports 40 correspond to the bridging prongs while port 45 is used to interconnect with the connector 10, with electronic leads 50 arranged to deliver the signal comprising, e.g., music.

Turning now to FIG. 3, the player module for interconnecting to the bridging device is shown in orthogonal view. In this figure, ports 40 and 45 are depicted in arrangement on the surface of the module designated for interconnection with the headphone set. As shown in this diagram, two locking mechanisms are provided, using a linking mechanism that connects interference bar 65 with switch 60. As switch 60 is moved inward, the linking mechanism causes the interference bar to engage the prong tip, thus locking the bridge onto the player module—and the connector into the connector port 45.

I claim:

1. A connection accessory for positively engaging a headphone connector with a player, said connection accessory comprising:
a bridge, having a headphone connection ring that provides a positive releasably engagement with a connector base of the headphones;
the bridge further comprising and opening for receiving and positioning a connector, and one or more connection prongs for engaging a player wherein the prongs extend into openings in said player and releasably attach the connector to the player.

2. The connection accessory of claim 1 wherein the bridge prong includes a hooking tip for engaging the player to create interference fit.

3. The connection accessory of claim 1 wherein the bridge prong further engages a moveable locking mechanism within the player.
